(19) United States
(12) Patent Application Publication
(10) Pub. No.: US 2013/0188818 A1
(43) Pub. Date: Jul. 25, 2013

(54) Karaoke Device

(71) Applicant: Stefan Betesh, Edison, NJ (US)

(72) Inventor: Stefan Betesh, Edison, NJ (US)

(73) Assignee: SAKAR INTERNATIONAL INC., Edison, NJ (US)

(21) Appl. No.: 13/354,262

(22) Filed: Jan. 19, 2012

(51) Int. Cl. H04R 1/02

(52) U.S. Cl. 381/333

(57) ABSTRACT

The Karaoke Device of the invention utilizes a computer tablet to connect to a speaker, microphone and computer tablet stand. The computer tablet stand can rotate for an enhanced visual performance and increased user-friendly design.

### CROSS-REFERENCE TO REALTED APPLICATIONS

Not Applicable

### STATEMENT REGARDING FEDERALLY SPONSERED RESEARCH OR DEVELOPMENT

Not Applicable

### REFERENCE TO SEQUENCE LISTEING, A TABLE, OR A COMPUTER PROGRAM LISTING COMPACT DISC APPENDIX

Not Applicable

### BACKGROUND OF THE INVENTION

Computer tablets have been utilized in karaoke machines. However, the position of the computer tablet has been rigid. This has taken away from the user's experience and performance. A less rigid design would rectify this design.

### BRIEF SUMMARY OF THE INVENTION

A Karaoke Device of the invention allows a user to connect a computer tablet to a karaoke machine. The computer tablet is positioned on a stand that can be rotated to the user's preference.

### BRIEF DESCRIPTION OF THE SEVERAL VIEWS OF THE INVENTION

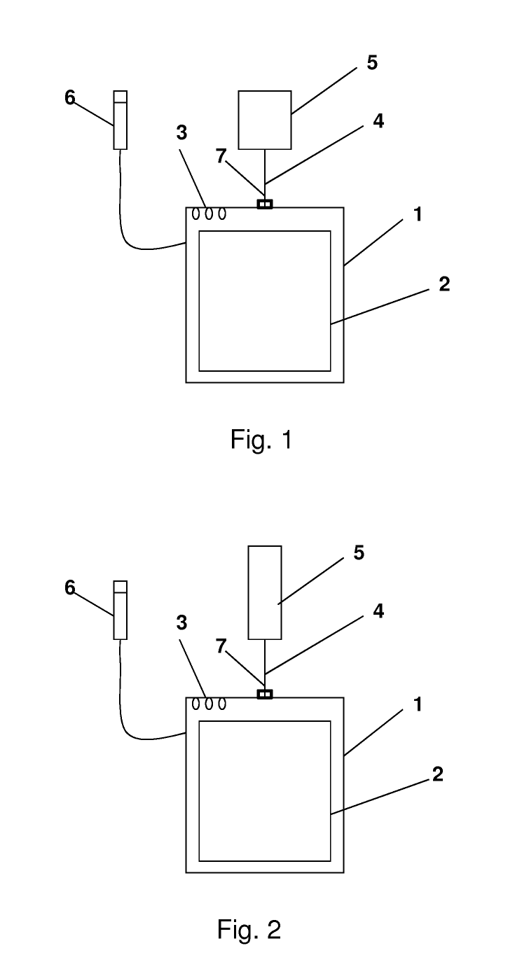

FIG. 1 is a front view of a Karaoke Device of the invention with a computer tablet rotated horizontally.

FIG. 2 is a front view of a Karaoke Device of the invention with a computer tablet rotated vertically.

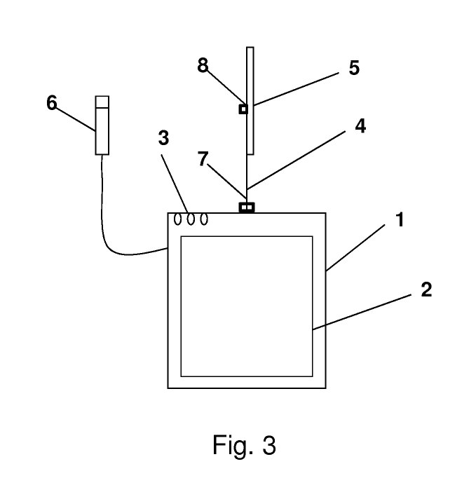

FIG. 3 is a front view of a Karaoke Device of the invention with a computer tablet rotated on its vertical axis.

### DETAILED DESCRIPTION OF THE INVENTION

A Karaoke Device of the invention can be built using a container 1 that includes a speaker 2. The speaker can have several control knobs 3 to adjust audio features. A computer tablet stand 4 rests on top of a rotating base 7, which rests on top of the container 1 as can be seen in FIG. 1, FIG. 2 and FIG. 3. The computer tablet 5 is attached to the computer tablet stand 4 and can rotate its position using the tablet rotating piece 8 attached to the computer tablet stand 4 as seen in FIG. 3. Between tablet rotating piece 8 and rotating base 7 the computer tablet stand 4 can be rotated on as many as three axes. A microphone can connect to the container 1 or the computer tablet 5.

What is claimed is:

1. A karaoke device comprising:
a speaker with or without audio control capabilities, a wireless or wired microphone, a computer tablet stand capable of rotating a computer tablet's position on at least one or a plurality of axes, and a computer tablet port.
